(19) United States
(12) Patent Application Publication
(10) Pub. No.: US 2025/0030187 A1
(43) Pub. Date: Jan. 23, 2025

(54) CONNECTING ELEMENT FOR A POTENTIOSTAT

(71) Applicant: MAGONTEC GmbH, Bottrop (DE)

(72) Inventors: Matthias Faaßen, Rees (DE); Ludwig Nachtigall, Rhede (DE)

(21) Appl. No.: 18/775,471

(22) Filed: Jul. 17, 2024

(30) Foreign Application Priority Data
Jul. 19, 2023 (DE) 10 2023 119 090.3

(51) Int. Cl. H01R 13/11; H01R 13/66; H01R 43/20

(52) U.S. Cl. CPC H01R 13/11; H01R 13/6683; H01R 43/205

(57) ABSTRACT

A connecting element for a potentiostat for producing an electrically conductive connection between an electrode with a hollow screw that includes a thread and the potentiostat. The connecting element includes a housing with a circuit board arranged inside the housing. The circuit board is configured to couple to the potentiostat via electrical conductors. A plug connector is arranged in the center of the circuit board for establishing a first electrical contact between the electrode and the circuit board by inserting the plug connector into the hollow screw. At least one spring contact pin is arranged on the circuit board for producing at least one further electrical contact between the electrode and the circuit board by inserting the plug connector into the hollow screw. The housing includes a spring element configured to hook into the thread and produce a form fit when the plug connector is inserted into the hollow screw

### PRIORITY CLAIM

This application claims priority to DE 10 2023 119 090.3, filed Jul. 19, 2023, which is hereby incorporated by reference in its entirety.

### BACKGROUND OF INVENTION

### Field of Invention

The invention relates to a connecting element for a potentiostat for establishing an electrically conductive connection between an electrode with a threaded hollow screw and the potentiostat.

### Brief Description of Related Art

A potentiostat is an electrical measuring device used in electrochemistry. In principle, it is a special design of a control amplifier that comprises three electrodes for the measurement: A working electrode, a high-resistance reference electrode and a counter electrode, all three of which are connected to a galvanic element to be analyzed during operation. The potentiostat maintains a constant electrical voltage between the working electrode and the reference electrode via an electrical current between the counter electrode and the working electrode. The potentiostat measures the electrical voltage and the electrical current and outputs them as measured values.

The electrode is usually rod-shaped. The electrode comprises a fastening means at one end of the rod. In addition to several threads and/or nuts, the fastening means consists primarily of a hollow screw, via which the electrode is conventionally connected to a blade terminal connected to the potentiostat via a screw connection. In addition to the screw connection, the polarity of the individual contacts must also be checked during assembly. Incorrect polarity poses a major risk of damage, particularly to the container to be protected. The container will corrode after a short time and start to leak. This not only results in a time-consuming installation, but is also prone to errors.

Based on this, the objective technical problem is to provide a connection element for connecting a conventional electrode to a potentiostat, which enables the electrode to be mounted quickly and safely.

### BRIEF SUMMARY OF THE INVENTION

This problem is solved by the inventions disclosed herein.

According to the invention, a connecting element is thus provided for a potentiostat for establishing an electrically conductive connection between an electrode with a hollow screw comprising a thread and the potentiostat, wherein the connection element comprises a housing and a printed circuit board arranged inside the housing, the printed circuit board can be coupled to the potentiostat via electrical conductors, a plug connector for producing a first electrical contact between the electrode and the printed circuit board by inserting the plug connector into the hollow screw is arranged in the center of the printed circuit board, at least one spring contact pin is arranged on the circuit board for establishing at least one further electrical contact between the electrode and the circuit board by inserting the plug connector into the hollow screw, and the housing comprises a spring element which is configured to hook into the thread and establish a form fit when the plug connector is inserted into the hollow screw.

The term “electrically conductive connection” is understood here in particular to mean a connection between two elements that are connected to each other by suitable means in such a way that a current can flow between the two elements.

The term “hollow screw” is understood here in particular to mean a screw that comprises a conventional thread on the outside and is at least partially hollow on the inside, whereby the hollow space is accessible from the outside so that a narrow and elongated component can be inserted into the hollow space of the screw.

The term “spring contact pins” refers to spring contacts, also known as pogo pins or SLC (Spring Loaded Contact), which are suitable for reliable contacting of uneven surfaces. Contact is made by touching a spring-loaded pin. This technology offers high functional reliability with a very high number of cycles and is therefore particularly suitable for use in power and data transmission.

The electrode is preferably a titanium anode. In this case, the hollow screw is also made of titanium. The metal titanium is characterized in particular by its durability, corrosion resistance and strength.

It is therefore an essential point of the invention that the connection between the electrode or the hollow screw and the circuit board is not made via a screw connection, but via a plug-in connection. Although the hollow screw comprises a thread, the connection is not ensured by means of a form fit via a screwing movement. Instead, a spring element engages in the recesses of the thread so that a form fit is created at least in the longitudinal direction of the electrode, i.e. in the direction of movement during assembly. The plug connector is plugged onto the hollow screw connected to the electrode. When the plug connector is inserted into the hollow screw, the spring element is pushed back. As soon as the connector is plugged onto the hollow screw, the spring element is pressed onto the thread and into at least one recess of the thread so that the spring element engages with the thread of the hollow screw. In this way, a universal plug can be provided that locks into place when it is plugged onto the electrode. This saves the installer a lot of time during assembly, as the connection is made by simply plugging the connection element onto the electrode. There is also no risk of polarity reversal during installation, as the electrical connections are made automatically via the spring contact pins when plugged in.

According to a preferred further embodiment of the invention, the spring element comprises two movable limbs that are connected to each other via a rigid limb. Further preferably, the plug connector is arranged between the movable limbs. The movable limbs preferably exert a spring force in the direction of the plug connector. The spring element is U-shaped. The two movable limbs are connected to each other via a rigid limb. The plug connector is arranged between the movable limbs or within the U-shape. When the plug connector is inserted into the hollow screw, the movable limbs are initially pressed apart against the spring force and then engage in the notches of the thread. The length of the rigid limb determines the distance between the movable limbs.

According to a preferred further embodiment of the invention, the housing comprises a spring guide in which the spring element is arranged. The spring guide limits the movement of the limbs in the direction of the connector. In particular, the spring guide can be understood as a recess in the housing in which the spring element or the limbs move. The recess is configured in such a way that the movable limbs are limited both against the spring force and in the direction of the spring force. This means that the limbs can only be pressed apart against the spring force up to a predetermined point during assembly and can only press against the thread of the hollow screw up to a predetermined point in the direction of the spring force during engagement.

According to a preferred further embodiment of the invention, one of the other electrical contacts comprises the ground connection. Reverse polarity can thus be reliably ruled out, as no polarity reversal is required during assembly. The electrical contacts are created automatically by inserting the plug connector into the hollow screw.

According to a preferred further embodiment of the invention, the connector comprises a banana plug. A banana plug is a round plug-in pin with a contact spring for laboratories, measuring devices and experiments. It is part of a connector system for low voltage. The plug is held securely in place by its spring, but can be easily removed without tools. The banana plug is also preferably a tufted plug. The tufted connector is a connector manufactured in accordance with DIN EN ISO 9001:2000. It is characterized in particular by its low contact resistance, high transmission performance, secure contact and robust design.

According to a preferred further embodiment of the invention, several spring contact pins, preferably three spring contact pins, particularly preferably five spring contact pins, are arranged in a circle around the plug connector on the circuit board. The connection element can be configured as a multi-pole connector as required. The number of poles is determined by the number of spring contact pins. These are arranged along a circle with the plug connector in the center.

According to a preferred further embodiment of the invention, a temperature sensor for measuring the temperature of a fluid surrounding the electrode is arranged on the circuit board. The heat of the fluid is conducted through the hollow screw, which is located in the water, into the connection element. The center connector is inserted circumferentially into the bore or cavity of the hollow screw. The center connector is in turn soldered to the circuit board on which the temperature sensor is soldered. With a certain correction factor, the fluid temperature can be measured with little effort.

According to a preferred further embodiment of the invention, the housing comprises a first opening, a second opening and an intermediate plate arranged between the openings. The intermediate plate preferably comprises several recesses for passing through the plug connector and the spring contact pins. The circuit board preferably lies flat against the side of the intermediate plate facing away from the first opening. The plug connector and the spring contact probes can be contacted on the side of the intermediate plate facing the first opening.

When the term “surface contact” is used here, it does not necessarily mean full-surface contact. Rather, it means in particular that the circuit board and the intermediate plate are arranged parallel to each other with little or no distance between them. Either the circuit board is in full contact with the intermediate plate, or the circuit board is only in contact with individual protruding elements of the intermediate plate. However, the distance between the circuit board and the intermediate plate is so small that the arrangement can be understood as “contact”. This results in a flush and space-saving design.

According to a preferred further embodiment of the invention, the spring element is arranged on the side of the intermediate plate facing away from the first opening. The connection element therefore comprises two sides. From one side, i.e. through the first opening, only the spring contact pins and the plug connector are accessible. The circuit board and the spring element are located on the other side of the intermediate plate and are only accessible through the second opening. However, the second opening is preferably closed with a cover so that the sensitive components are not accessible and protected during assembly. Due to this design, the connection element is particularly robust and less susceptible to damage.

According to the invention, the use of a connection element described above for producing an electrically conductive plug-in connection between an electrode and a potentiostat is also provided. Consequently, a screw connection is no longer required when connecting the potentiostat to the electrode. The connection element according to the invention can be connected to any conventional electrode by simply plugging it on and snapping it into place.

### BRIEF DESCRIPTION OF THE DRAWINGS

In the following, the invention is explained in further detail with reference to the figures by means of a preferred embodiment example.

The figures show in:

FIG. 1 schematically a perspective view of an electrode and a connection element according to a preferred embodiment of the invention;

FIG. 2a schematically a perspective view of the housing of the connection element from FIG. 1;

FIG. 2b schematically a perspective view of the circuit board of the connection element from FIG. 1;

FIG. 3 schematically a perspective view of the housing and the circuit board of the connection element shown in FIGS. 2a and 2b in an assembled state; and

FIG. 4a, 4b schematically a perspective view of the connection element from FIG. 3 in the closed state.

### DETAILED DESCRIPTION OF PREFERRED EMBODIMENTS OF THE INVENTION

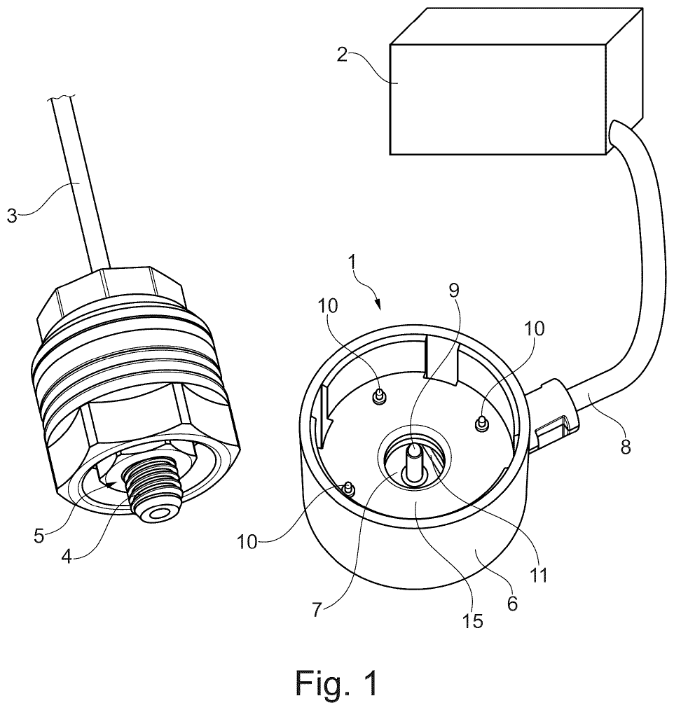

FIG. 1 schematically shows a potentiostat 2 with a connection element 1 and a conventional electrode 3. The electrode 3 is rod-shaped and comprises a hollow screw 5 at one end as a fastening means. The hollow screw 5 is provided with a thread 4 on the outside, which is conventionally used to create a screw connection.

The connection element 1 comprises a housing 6 in which the circuit board 7 is installed. The connection element 1 is shown in a slightly oblique top view. This means that the components installed behind the intermediate plate 15 are not visible. The spring contact pins 10 and the centrally positioned plug connector 9 are inserted through the recesses 16. The spring element 11 is located behind the intermediate plate 15. The connection element 1 is connected to the potentiostat 2 via electrical conductors 8 so that a current flow or data transmission is possible.

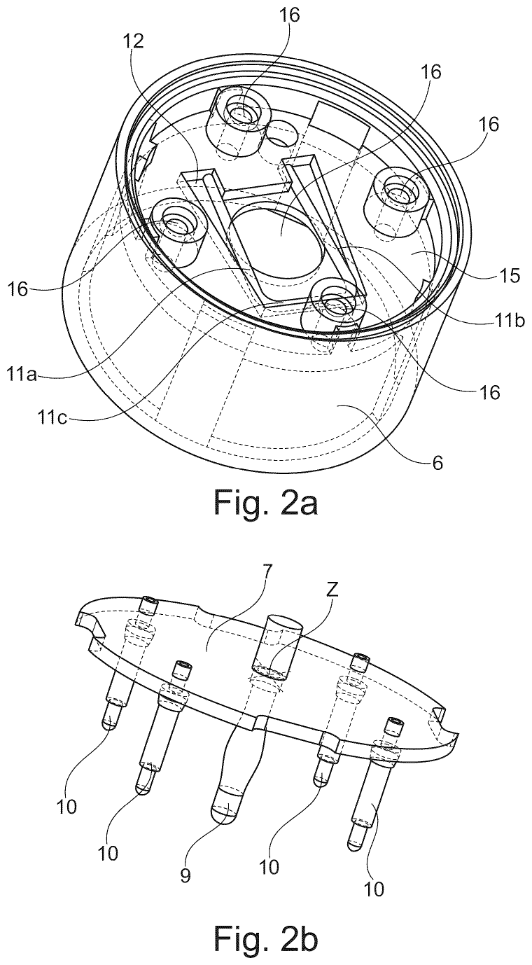

To show the structure of the connection element 1 in more detail, the connection element 1 from FIG. 1 is shown in an open state from below in FIGS. 2a and 2b. The area shown in FIG. 1 is behind or below the intermediate plate 15.

The intermediate plate 15 comprises several recesses 16 for the spring contact pins 10 and the plug connector 9. The spring element 11 is arranged around the central recess through which the plug connector 9 is inserted. The spring element 11 is made up of three limbs 11a, 11b, 11c. Two limbs 11a, 11b are movable and connected to each other via a rigid limb 11c. The limbs 11a, 11b, 11c are arranged in a U-shape and enclose the recess through which the plug connector 9 is inserted. The spring element 11 is arranged in a spring guide 12. The spring guide 12 consists of a recess in the intermediate plate 15, in which the movable limbs 11a, 11b can move. The spring force acts radially in the direction of the central recess 16 or in the direction of the plug connector 9. When the plug connector 9 is inserted into the hollow screw 5, the movable limbs 11a, 11b are moved against the spring force as far as the stop of the spring guide 12. As soon as the connection element 1 is plugged onto the thread 4 of the hollow screw 5, the movable limbs 11a, 11b engage in the notch of the thread 4 and lock the hollow screw 5 or the complete electrode 3.

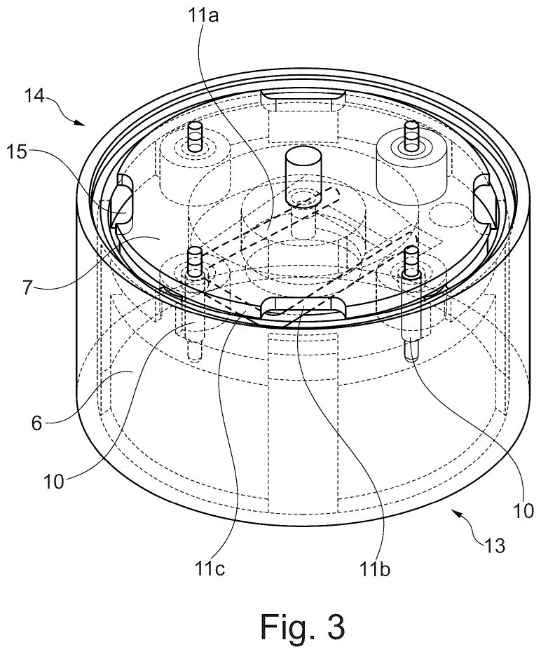

FIG. 2b shows the circuit board 7 with the plug connector 9 in the center Z and a total of four spring contact pins 10, which are arranged in a circle around the plug connector 9. The spring contact pins 10 and the plug connector 9 are inserted through the recesses 16 in the intermediate plate 15 so that the circuit board 7 lies almost flat against the intermediate plate 15. This state is shown in FIG. 3.

The connection element 1 is shown in an oblique top view of the second opening 14, which is to be understood as the base and is closed with a cover not shown here. The spring contact pins 10 and the plug connector 9 are inserted through the recesses 16 of the intermediate plate 15 and are only accessible through the first opening 13, as shown in FIG. 1. The spring element 11 is arranged between the intermediate plate 15 and the circuit board 7 so that it is no longer freely accessible. As soon as the plug connector 9 is plugged onto the hollow screw 5, the movable limbs 11a, 11b engage in the thread 4 of the hollow screw. In this state, electrical contacts are established between the spring contact pins 10 and the electrode 3 as well as between the plug connector 9 and the electrode 3, so that the potentiostat 2 is ready for use.

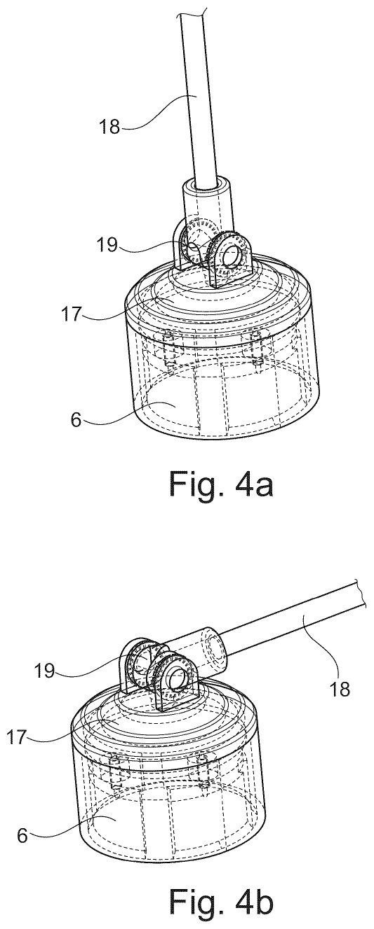

FIG. 3 shows the connection element 1 in the assembled state. The circuit board 7 is inserted into the housing 6. The plug connector 9 and the spring contact pins 10 are inserted through the recesses 16 and point away from the second opening 14 and are located inside the housing 6. The spring element 11 is arranged between the intermediate plate 15 and the circuit board 7 in such a way that it at least partially encloses the plug connector. This housing is closed with a cover 17. This state is shown in FIGS. 4a and 4b.

FIGS. 4a and 4b differ in the position of the cable outlets. The cable guard 18 is attached to the box 17 via a movable connecting element 19. The movement is ensured by means of a joint that comprises a latching mechanism so that the cable protection can be latched at different angles to the box. This enables flexible installation, as the outgoing cable protection 18 can be arranged and fixed in any position between a vertical alignment and a horizontal alignment.

### LIST OF REFERENCE SYMBOLS APPEARING IN THE DRAWING FIGURES

The following reference symbols appear in the drawing figures:
1 Connecting element
2 Potentiostat
3 Electrode
4 Thread
5 Hollow screw
6 Housing
7 Circuit board
8 Electrical conductors
9 Plug connector
10 Spring contact pin
11 Spring element
11a Movable limb
11b Movable limb
11c Rigid limb
12 Spring guide
13 First opening
14 Second opening
15 Intermediate plate
16 Recess
17 Lid
18 Cable protection
19 Coupling element
Z Center

What is claimed is:

1. A connecting element for a potentiostat for establishing an electrically conductive connection between an electrode with a hollow screw comprising a thread and the potentiostat, wherein:
the connecting element comprises a housing and a circuit board arranged inside the housing;
the circuit board is configured to be coupled to the potentiostat via electrical conductors;
a plug connector is arranged in the center of the circuit board for establishing a first electrical contact between the electrode and the circuit board by inserting the plug connector into the hollow screw;
at least one spring contact pin is arranged on the circuit board for establishing at least one further electrical contact between the electrode and the circuit board by inserting the plug connector into the hollow screw; and
the housing comprises a spring element which is configured to hook into the thread when the plug connector is inserted into the hollow screw and to establish a form fit.

2. The connecting element according to claim 1, wherein:
the spring element comprises two movable limbs which are connected to one another via a rigid limb;
the plug connector is arranged between the movable limbs; and
the movable limbs exert a spring force in the direction of the plug connector.

3. The connecting element according to claim 1, wherein:
the housing comprises a spring guide in which the spring element is arranged; and
the spring guide limits the movement of the movable limbs in the direction of the plug connector.

4. The connecting element according to claim 1, wherein one of the further electrical contacts comprises the ground connection.

5. The connecting element according to claim 1, wherein the plug connector comprises a banana plug.

6. The connecting element according to claim 1, wherein a plurality of spring contact pins are arranged in a circle around the plug connector on the circuit board.

7. The connecting element according to claim 6, wherein
three spring contact pins are arranged in a circle around the plug connector on the circuit board.

8. The connecting element according to claim 6, wherein five spring contact pins are arranged in a circle around the plug connector on the circuit board.

9. The connecting element according to claim 1, wherein a temperature sensor for measuring the temperature of a fluid surrounding the electrode is arranged on the circuit board.

10. The connecting element according to claim 1, wherein:
the housing comprises a first opening, a second opening and an intermediate plate arranged between the openings;
the intermediate plate comprises a plurality of recesses for passing through the plug connector and the spring contact pins;
the printed circuit board lies flat against the side of the intermediate plate facing away from the first opening; and
the plug connector and the spring contact pins are configured to be contacted on the side of the intermediate plate facing the first opening.

11. The connecting element according to claim 10, wherein the spring element is arranged on the side of the intermediate plate facing away from the first opening.

12. A method for producing an electrically conductive plug-in connection between an electrode and a potentiostat provided with electrical conductors, the method comprising coupling the electrode to a connecting element according to claim 1 such that the circuit board arranged inside the housing of the connecting element is coupled to the potentiostat via the electrical conductors.
